(19) United States
(12) Patent Application Publication
(10) Pub. No.: US 2016/0354795 A1
(43) Pub. Date: Dec. 8, 2016

(54) DEVICE FOR PACKAGING AND DISPENSING PASTY PRODUCTS

(71) Applicant: LABLABO, Juvigny (FR)

(72) Inventors: Jean- Philippe Taberlet, Villard (FR); Patrice Puviland, Eteaux (FR)

(21) Appl. No.: 15/115,492

(22) PCT Filed: Jan. 29, 2015
(86) PCT No.: PCT/FR2015/050201

§ 371 Date: Jul. 29, 2016

(30) Foreign Application Priority Data
Jan. 30, 2014 (FR) 14 50720

(51) Int. Cl. B05B 11/00

(52) U.S. Cl. CPC B05B 11/3047; B05B 11/0043; B05B 11/0013

(57) ABSTRACT

The invention relates to a device for packaging and dispensing pasty products, comprising a rigid bottle (1) bearing a pump (2) mounted on a ring (3) fixed in the neck of the rigid bottle (1) by means of a fixing arrangement (4) and secured to the neck of a pouch (5) having a flexible and deformable wall and containing the product to be dispensed, said ring (3) comprising, from the outside to the inside, a rim (3A) for fixing in the rigid bottle (1), a downwardly descending, substantially vertical wall (3B), an upwardly rising inclined shoulder (3C) and a substantially vertical flange (3D) for fixing the pump (2), said fixing arrangement (4) having a lower end situated at or above the upper edge of said shoulder (3C) of the ring.

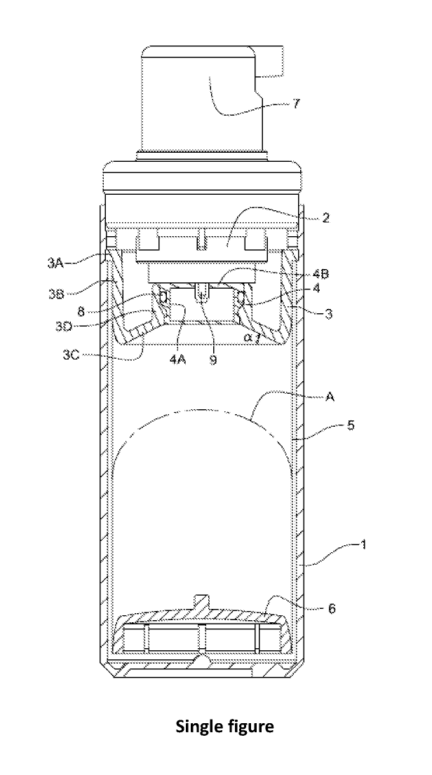

According to the invention, the inclination angle (α) of said shoulder (3C) with respect to a horizontal plane is between 20 and 30 degrees.

The invention relates to a device for packaging and dispensing pasty products.

It relates more specifically to a device for packaging and dispensing pasty produces, comprising a rigid bottle bearing a pump mounted by means of a fixing arrangement on a ring fixed in the neck of the rigid bottle and secured to the neck of a pouch having a flexible and deferrable wall and containing the product to be dispensed, the ring comprising, from the outside to the inside, a rim for fixing in the rigid bottle, a downwardly descending, substantially vertical wall, an upwardly rising inclined shoulder and an upwardly directed, substantially vertical flange for fixing the pump.

The patent document FR 2 989 598 discloses such a device for packaging and dispensing fluid products having a manual pump.

Such a device comprises a rigid bottle bearing a pump actuated by a push button, said pump being mounted on a ring snap-fastened into the neck of the rigid bottle and secured to the neck of a pouch having a flexible and deformable wall and containing the product to be dispensed. The flexible-wall pouch is closed off in its bottom part by a cup fixed in a sealed manner to the wall of this pouch.

The ring comprises, from the outside to the inside, a rim for snap-fastening in the rigid bottle, a downwardly descending, substantially vertical wall, an upwardly rising inclined shoulder and an upwardly directed, substantially vertical flange for fixing the pump or equivalent, taking into account the fact that, according to this document, an ancillary closure means is provided.

Furthermore, the patent document US 2006/0255272 describes a device for packaging and dispensing pasty products, comprising a rigid bottle bearing a pump mounted on a ring fixed in the neck of the rigid bottle by means of a fixing arrangement and secured to the neck of a pouch having a flexible and deformable wall and containing the product to be dispensed, said ring comprising, from the outside to the inside, a rim for fixing in the rigid bottle, a downwardly descending, substantially vertical wall, an upwardly rising inclined shoulder, and a substantially vertical flange for fixing the pump, said fixing arrangement having a lower end situated at or above the upper edge of said shoulder of the ring.

The object of the invention is to improve such a device. Specifically, it has been found that the behavior of a pasty produce during the filling of the flexible-wall pouch results in the formation of an upper surface of this product with a convex domed shape. During the filling of the flexible-wall pouch, on account of this convex domed shape, the edges of this surface that are disposed at a level lower than that of its central part can cause an air pocket to remain between the product and the ring, more precisely under its inclined shoulder.

When the pump is used, the product contained in the pouch is drawn up in order to be dispensed in precise and reproducible metered quantities. However, it is possible on occasion for a part of the residual air pocket to be drawn up at the same time as the product, thereby risking compromising the precision and regularity of the metered quantities of product dispensed by the pump.

Furthermore, it is important to find a good compromise between avoiding the formation of bubbles and air pockets and having a structure with ergonomic bulk, it being important that the volume of the ring does not excessively impinge upon the internal volume of the flexible-wall pouch.

The invention resolves this problem and proposes such a compromise.

It proposes a device for packaging and dispensing pasty products, comprising a rigid bottle bearing a pump mounted by means of a fixing arrangement on a ring fixed in the neck of the rigid bottle and secured to the neck of a pouch having a flexible and deformable wall and containing the product to be dispensed, said ring comprising, from the outside to the inside, a rim far fixing in the rigid bottle, a downwardly descending, substantially vertical wall, an upwardly rising inclined shoulder and a substantially vertical flange far fixing the pump, said fixing arrangement having a lower end situated at or above the upper edge of said shoulder of the ring, said device being characterized in that the inclination angle of said shoulder with respect to a horizontal plane is between 20 and 30 degrees.

According to a preferred embodiment, said inclination angle is around 25 degrees.

Preferably, said fixing arrangement consists of a cylindrical part, the side wall of which is fixed to said flange of the ring.

Said cylindrical part can be fixed to said flange of the ring by snap-fastening.

Advantageously, a seal is disposed between said cylindrical part and said flange of the ring.

The height of this aide wall is preferably substantially equal to the height of said flange of the ring.

Said cylindrical pert preferably has a top end secured to the pump.

Preferably, said flexible-wall pouch comprises a sheet of aluminum interposed between at least two plastic films and, advantageously, said plastic films are made of polyethylene.

The invention is described in more detail below with the aid of a FIGURE showing a preferred embodiment of the invention.

This FIGURE is a vertical cross-sectional view of a device for packaging and dispensing pasty products in accordance with the invention.

A device for packaging and dispensing pasty products comprises a rigid bottle 1 bearing a pump 2 actuated by a push button 7, mounted by means of a fixing arrangement 4 on a ring 3 fixed in the neck of the rigid bottle 1 and secured to the neck of a pouch 5 having a flexible and deformable wall and containing the product to be dispensed. The flexible-wall pouch 5 is closed off in its bottom part by a cup 6 fixed in a sealed manner to the wall of this pouch 5.

The ring 3 comprises, from the outside to the inside, a rim 3A for fixing, for example by snap-fastening, in the rigid bottle 1, a downwardly descending, substantially vertical wall 3B an upwardly rising inclined shoulder 3C and an upwardly directed, substantially vertical flange 3D for fixing the pump.

The inclination angle α of the inclined shoulder 3C of the ring with respect to a horizontal plane is between 20 and 30 degrees and preferably equal to around 25 degrees.

Furthermore, the fixing arrangement 4 for fixing the pump on the ring 3 has a lower end situated at or above the top end of this shoulder 3C of the ring. In other words, no part protrudes downwards below the ring 3.

This fixing arrangement 4 consists of a cylindrical part, the side wall 4A of which is fixed to the flange 3D of the ring by snap-fastening, with an O-ring seal 8 interposed.

The height of this side wall is in this case substantially equal to the height of the flange 3D of the ring.

The cylindrical part 4 has a top end 4B secured to the pump.

The curve A illustrates, at a given filling level for better visibility, the convex domed shape of the upper surface of a pasty product within the flexible-wall pouch 5. During operation of the device and while the pump is being actuated, this flexible-wall pouch 5 contracts and pushes the product and thus its upper surface towards the ring 3 and towards the intake 9 of the pump.

By virtue of the invention, because the angle α of the shoulder 3C is relatively large and because no part protrudes downwards below the ring 3, the formation of air bubbles is minimized or even eliminated, the upper surface A of the pasty product contained in the pouch 5 closely following the lower shape of the ring 3, unlike the prior art, where this angle is smaller by around 10 degrees.

Furthermore, by virtue of the invention, better filling of the pouch 5 is obtained, this upper surface of the product A closely fallowing the lower shape of the ring 3 during the filling of the pasty product into the pouch.

Finally, it has bean observed that more consistent metered quantities are obtained over time, as a result of better filling by contraction of the pouch 5.

Preferably, the flexible-wall pouch 5 comprises a multilayer complex combining several metal films, or a metal sheet coated with a plastic film on at least one of its faces. One particularly advantageous embodiment comprises an aluminum sheet interposed between at least two plastic films. The plastic films of the multilayer complexes can be chosen from a polyethylene, a polypropylene, a polyamide, etc.

It is also possible for the complex to have four layers, i.e. polyethylene/polyamide/aluminum/polyethylene terephthalate, or polyethylene/polyethylene teraphthalate/aluminum/polyethylene.

This last multilayer structure has the advantage of facilitating edge-to-edge fixing after rolling up of the sheet, by adhesive bonding or by welding, since the internal part of one edge of the sheet is pressed against the external part of the other edge, which is made of the same material.

1. Device for packaging and dispensing pasty products, comprising:
a rigid bottle bearing a pump mounted on a ring fixed in the neck of the rigid bottle by of a fixing arrangement and secured to the neck of a pouch having a flexible and deformable wall and containing the product to be dispensed, said ring having, from the outside to the inside, a rim for fixing in the rigid bottle, a downwardly descending, substantially vertical wall, an upwardly rising inclined shoulder and a substantially vertical flange for fixing the pump, said fixing arrangement having a lower end situated at or above the upper edge of said shoulder of the ring, wherein the inclination angle of said shoulder with respect to a horizontal plane is between 20 and 30 degrees.

2. Device according to claim 1, wherein said inclination angle is around 25 degrees.

3. Device according to claim 1, wherein said fixing arrangement consists of a cylindrical part, the side wall of which is fixed to said flange of the ring.

4. Device according to claim 3, wherein said cylindrical part is fixed to said flange of the ring by snap-fastening.

5. Device according to claim 3, wherein a seal is disposed between said cylindrical part and said flange of the ring.

6. Device according to claim 3, wherein the height of this side wall is substantially equal to the height of said flange of the ring.

7. Device according to claim 3, said cylindrical part has a top end secured to the pump.

8. Device according to claim 1, wherein said flexible-wall pouch has a sheet of aluminum interposed between at least two plastic films.

9. Device according to claim 8, wherein said plastic films are made of polyethylene.
